(19) United States
(12) Patent Application Publication
(10) Pub. No.: US 2011/0235682 A1
(43) Pub. Date: Sep. 29, 2011

(54) Method and apparatus for determining reference signals in mobile communication system

(75) Inventors: Hong He, Beijing (CN); Yingyang Li, Beijing (CN); Chengjun Sun, Beijing (CN)

(73) Assignees: SAMSUNG ELECTRONICS CO., LTD., Suwon-si (KR); BEIJING SAMSUNG TELECOM R & D CENTER, Beijing (CN)

(21) Appl. No.: 13/065,646

(22) Filed: Mar. 25, 2011

(30) Foreign Application Priority Data
Mar. 26, 2010 (CN) 201010135733.8

(51) Int. Cl. H04B 1/713

(52) U.S. Cl. 375/132; 375/E01.033

(57) ABSTRACT

Embodiments of the present invention provide a method and an apparatus for determining reference signals. A User Equipment (UE) obtains group hopping information and/or sequence hopping information of a UE-specific reference signal from cell-specific system information broadcasted by an eNB. The UE receives UE-specific control information transmitted by the eNB to the UE. The UE generates a UE-specific reference signal of a first slot according to the group hopping information and/or sequence hopping information of the broadcasted cell-specific reference signal. If the UE-specific control information indicates that group hopping and/or sequence hopping of UE-specific reference signals is disabled, the UE generates a UE-specific reference signal of a second slot in a same frame with the first slot according to the UE-specific reference signal of the first slot. The UE is able to determine the reference signals when multiple UEs share physical resource blocks.

### CROSS-REFERENCE TO RELATED APPLICATION(S) AND CLAIM OF PRIORITY

The present application claims the benefit under 35 U.S.C. §119(a) to a Chinese patent application filed in the Chinese Intellectual Property Office on Mar. 26, 2010 and assigned Serial No. 201010135733.8, the entire disclosure of which is hereby incorporated by reference.

### TECHNICAL FIELD OF THE INVENTION

The present invention relates to mobile communications techniques and, more particularly, to a method and an apparatus for determining reference signals.

### BACKGROUND OF THE INVENTION

A Long Term Evolution (LTE) system has two types of frame structures, i.e. a frame structure under an LTE Frequency Division Duplex (FDD) system and a frame structure under an LTE Time Division Duplex (TDD) system.

FIGURE 1A and FIG. 1B are schematic diagrams that respectively show these two kinds of frame structures according to the principles of the present invention.

FIG. 1A shows a radio frame structure under the LTE FDD system. As shown in FIG. 1A, the radio frame is 307200xTₛ=10 ms long and consists twenty slots of length 15360Tₛ=0.5 ms, numbered from ‘0’ to ‘19’. One slot includes multiple Orthogonal Frequency Division Multiplexing (OFDM) symbols. Each OFDM symbol has a Cyclic Preamble (CP). During implementation, there are two manners to realize the CP, i.e. normal CP and extended CP. A slot with a normal CP contains 7 OFDM symbols and a slot with an extended CP contains 6 OFDM symbols.

FIG. 1B shows a radio frame structure under the LTE

TDD system. As shown in FIG. 1B, the radio frame is 307200xTₛ=10 ms long and is equally divided into two half-frames of length 153600xTₛ=5 ms each. Each half-frame includes 8 slots of length 15360Tₛ=0.5 ms and 3 special fields in a special subframe, i.e. a Downlink Pilot Time Slot (DwPTS), a Guard Period (GP) and an Uplink Pilot Time Slot (UpPTS). A total length of the DwPTS, the GP, and the UpPTS is 30720Tₛ=1 ms . Each slot includes multiple OFDM symbols. Similar as the radio frame under the LTE FDD system, a slot with a normal CP contains 7 OFDM symbols and a slot with an extended CP contains 6 OFDM symbols.

A subframe is defined as two consecutive slots. For example, subframe k includes slots 2k and 2k+1. Based on this, FIG. 1B shows subframes, i.e. subframe ‘0’ to subframe ‘9’, formed by slots. In FIG. 1B, subframe ‘1’ and subframe ‘6’ contain the above mentioned 3 special fields. According to a discussed result of 3rd Generation Partnership Project (3GPP) with respect to the LTE standard, subframe ‘0’, subframe ‘5’, and the DwPTS are reserved for downlink (DL) transmission. As to a 5 ms periodicity, the UpPTS, subframe ‘2’, and subframe ‘7’ are reserved for uplink (UL) transmission. As to 10 ms periodicity, the UpPTS and subframe ‘2’ are reserved for uplink transmission.

FIG. 2A illustrates a configuration of a single uplink subframe under normal CP according to the principles of the present invention. The configuration mainly includes a distribution of time-frequency resources, and time-frequency positions may be applied for transmitting a Reference Signal (RS), a Physical Uplink Shared Channel (PUSCH), and a Sounding Reference Signal (SRS). As shown in FIG. 2A, the uplink subframe contains two slots in each Resource Block (RB). Each slot includes seven Single Carrier Frequency Division Multiple Access (SC-FDMA) symbols in the time domain. As such, the uplink subframe contains fourteen symbols, i.e. symbol ‘0’ to symbol ‘13’ in the time domain and includes twelve subcarriers, i.e. subcarrier ‘0’ to subcarrier ‘11’ in the frequency domain, wherein the fourth symbol in the first slot and the third symbol in the second slot are used for transmitting the RS, and the last symbol is used for transmitting the SRS.

In the LTE system, available Cell Identities (Cell IDs) are within ‘1’ - ‘504’. And a sequence group number u of available Constant Amplitude Zero Auto Correlation (CAZAC) sequences is within a range of 0≦u≦29. In order to avoid inter-cell interferences of reference signals, the LTE system determines the sequence group number u of a reference signal sequence according to an existing frequency-hopping method, and adopts higher layer signaling group-hopping-enabled and sequence-hopping-enabled to indicate all UEs in the cell whether group/sequence hopping should be performed within two consecutive slots.

However, the LTE system supports only a fair bandwidth allocation Multi-User Multiple Input and Multiple Output (MU-MIMO), as shown in FIG. 2B. On this basis, a CAZAC sequence may be taken as a base sequence of the uplink reference signal. As such, when an enhanced Node B (eNB) allocates the same time-frequency resources to multiple UEs, the eNB may indicate, in downlink control information, different UEs to use different cyclic shifts (CSs) (to which Orthogonal Code Cover (OCC) may be applied) of the same base sequence within the same slot to ensure the orthogonality of uplink reference signals. But this will restrict the scheduling of the uplink resources, thereby affecting the uplink throughput of the whole system.

In the LTE-A (LTE Advance) system, there is a higher requirement for the uplink throughput and spectrum efficiency of the whole system. In order to meet the requirement of the LTE-A system, UEs in the LTE-A system support uplink data transmission on multiple antennas. But the LTE-A system does not give a method for the UE to determine the reference signals when the flexible bandwidth allocation MU-MIMO manner as shown in FIG. 2C is adopted.

### SUMMARY OF THE INVENTION

To address the above-discussed deficiencies of the prior art, it is a primary object to provide a method and an apparatus for determining reference signals, so as to enable a UE in a cell to determine the reference signals when multiple UEs shares physical resource blocks.

The technical solution provided by the embodiments of the present invention is as follows.

According to an embodiment of the present invention, method for determining reference signals is provided. Group hopping information and/or sequence hopping information of a UE-specific reference signal from cell-specific system information broadcasted by an eNB is obtained by a User Equipment (UE). UE-specific control information transmitted by the eNB is received by the UE. A UE-specific reference signal of a first slot is generated by the UE according to the group hopping information and/or sequence hopping information of the broadcasted UE-specific reference signal. If the UE-specific control information indicates that group hopping and/or sequence hopping of the UE-specific reference signal is disabled, a UE-specific reference signal of a second slot is generated in a same frame with the first slot according to the UE-specific reference signal of the first slot.

According to another embodiment of the present invention, an apparatus in a User Equipment (UE) for determining reference signals is provided. The apparatus includes a controller, a receiver, and a generator. The controller obtains at least one of group hopping information and sequence hopping information of a UE-specific reference signal from cell-specific system information broadcasted by an enhanced Node B (eNB). The receiver receives UE-specific control information transmitted by the eNB to the UE. The generator is controlled by the controller and generates a UE-specific reference signal of a first slot according to at least one of the group hopping information and the sequence hopping information of the broadcasted UE-specific reference signal. If the UE-specific control information indicates that at least one of group hopping and sequence hopping of UE-specific reference signals is disabled, the generator generates a UE-specific reference signal of a second slot in a same frame with the first slot according to the UE-specific reference signal of the first slot

It can be seen from the above technical solution that, in the present invention, the UE is able to determine the cell-specific reference information of a subframe according to the cell-specific system information and control information. No additional physical layer bit overhead is added to the eNB. In addition, the present invention does not restrict the application scenario as occurs in the prior art. Various application scenarios including SU (Single User) -MIMO, fair bandwidth allocation MU-MIMO and flexible bandwidth allocation MU-MIMO are fully considered. The method for generating the reference signals for the UE is flexibly configured, which realizes the orthogonality of the reference signals of shared resource blocks when the eNB schedules, on the same frequency resource within one subframe, multiple UEs which share physical resource blocks by the flexible bandwidth allocation MU-MIMO manner.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A illustrates a diagram of a radio frame under the LTE FDD system according to the principles of the present invention;

FIG. 1B illustrates a diagram of a radio frame under the LTE TDD system according to the principles of the present invention;

FIG. 2A shows a configuration of a single uplink subframe under normal CP according to the principles of the present invention;

FIG. 2B illustrates a diagram of resource multiplexing of fair bandwidth allocation MU-MIMO according to the principles of the present invention;

FIG. 2C illustrates a diagram of resource multiplexing of flexible bandwidth allocation MU-MIMO according to the principles of the present invention;

FIG. 3 illustrates a process for determining a reference signal according to an embodiment of the present invention;

FIG. 4 illustrates a process for determining a reference signal when there is no group hopping according to an embodiment of the present invention;

FIG. 5A illustrates a diagram of DCI in control information according to an embodiment of the present invention;

FIG. 5B illustrates a diagram of a hopping flag according to an embodiment of the present invention;

FIG. 6 illustrates a process for determining a reference signal when there is group hopping according to an embodiment of the present invention;

FIG. 7 illustrates a process for determining a reference signal in a bi-antenna scenario according to an embodiment of the present invention; and

FIG. 8 illustrates a diagram of the DCI in the control information according to an embodiment of the present invention.

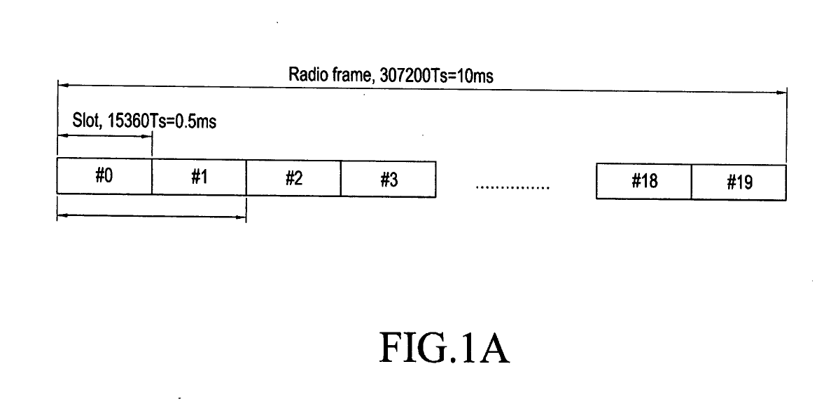

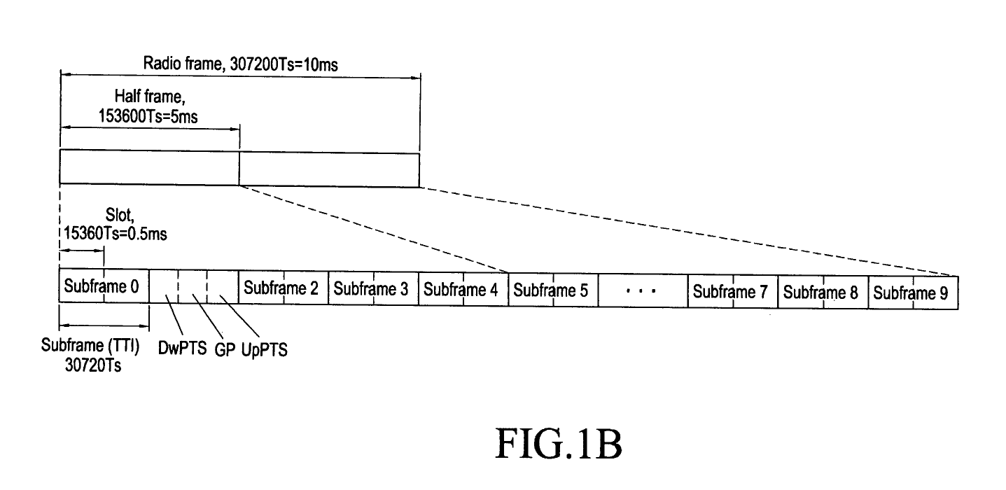

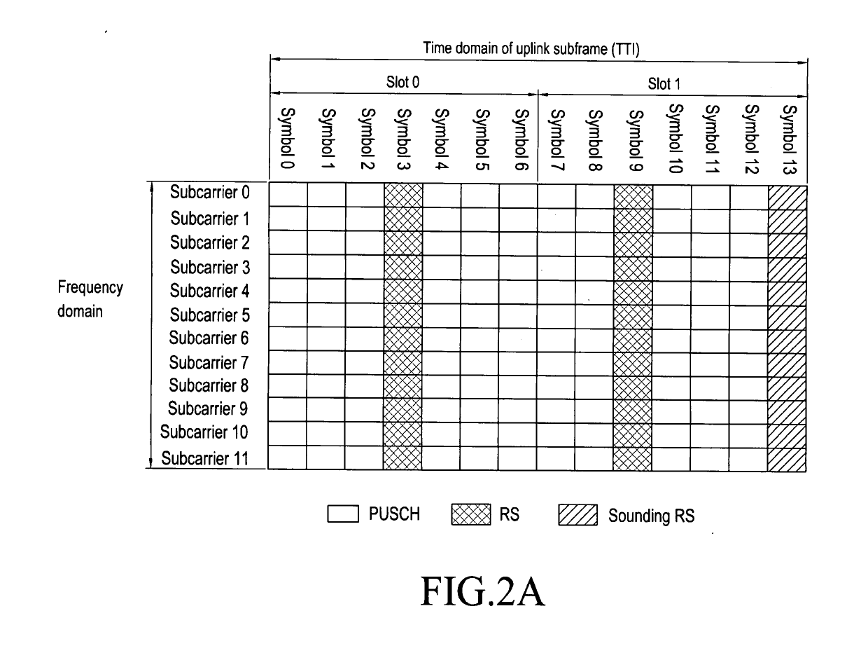

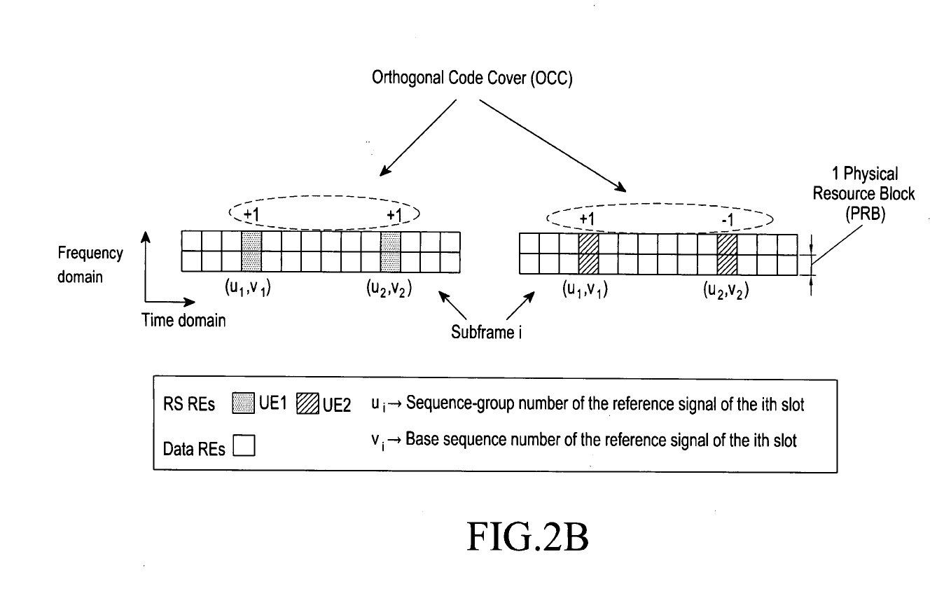

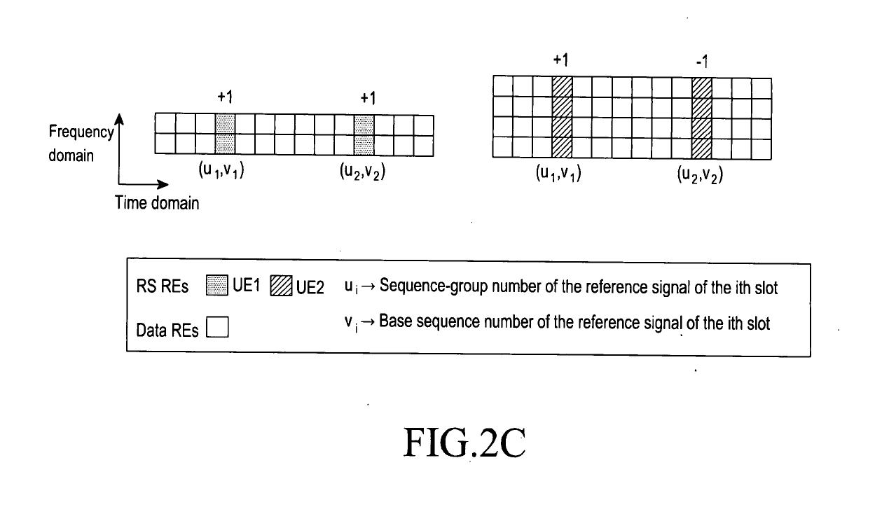

### DETAILED DESCRIPTION OF THE INVENTION

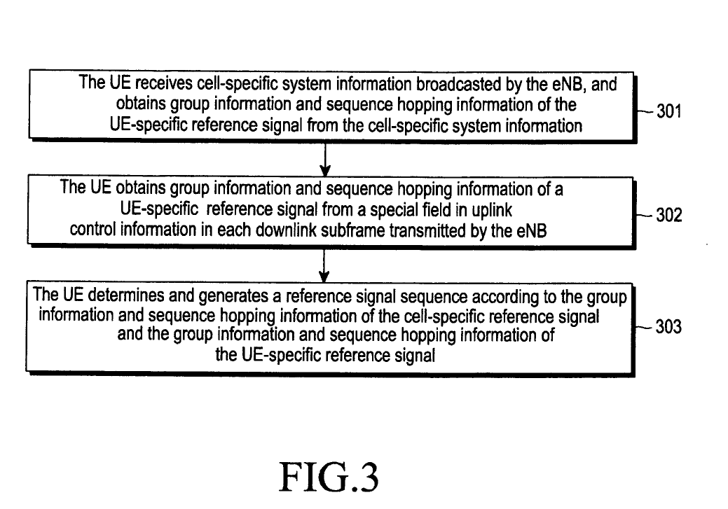

FIGS. 3 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication device. The method provided by the present invention mainly includes a UE that obtains group hopping information and/or sequence hopping information of a UE-specific reference signal from cell-specific system information broadcasted by an eNB. The UE receives specific control information transmitted by the eNB to the UE. The UE generates a UE-specific reference signal of a first slot according to the group hopping information and/or the sequence hopping information of the UE-specific reference signal obtained. And if the specific control information indicates that the group hopping and/or the sequence hopping of the UE-specific reference signal is disabled, a UE-specific reference signal of a second slot is kept in the same subframe consistent with the UE-specific reference signal of the first slot.

In the above description, the group hopping and the sequence hopping of the reference signal exist concurrently or individually. For simplicity, in the following embodiments, the situation in which the group hopping information and the sequence hopping information of the reference signal exist at the same time is taken as an example. The present invention will be described in further detail hereinafter with reference to accompanying drawings and embodiments to clarify the objective, technical solution, and merits.

A process provided by an embodiment of the present invention is shown in FIG. 3. As shown in FIG. 3, the method mainly includes the following operations.

In block 301, the UE receives cell-specific system information broadcasted by the eNB and obtains group information and sequence hopping information of a UE-specific reference signal from the cell-specific system information received.

Herein, the group information of the UE-specific reference signal may be group hopping information during practical implementations.

In block 302, the UE obtains group information and sequence hopping information of a UE-specific reference signal from a special information field in Uplink Control Information (UCI) of each downlink subframe transmitted by the eNB.

Herein, the eNB transmits UE-specific control information which may include the UCI. Thus, block 302 may specifically include the UE detecting the UE-specific control information in a searching space corresponding to the UE and obtaining the UCI from the UE-specific control information detected. The UE then obtains the group information and the sequence hopping information of the UE-specific reference signal from the specific information filed in the UCI.

In block 303, the UE determines and generates a reference signal sequence according to the group information and sequence hopping information of the UE-specific reference signal obtained in block 301 and the group information and the sequence hopping information of the UE-specific reference signal obtained in block 302. The UE then maps the reference signal sequence generated to specific physical resources and transmits the generated reference signal together with data.

The operations for generating the reference signal sequence in block 303 is similar to those in the prior art and, as such, will not be described herein.

It can be seen from the above that, the present invention does not restrict the application scenario, in contrast to the prior art. Various application scenarios such as SU-MIMO, fair bandwidth allocation MU-MIMO and flexible bandwidth allocation MU-MIMO are fully considered. The present invention flexibly configures the method for generating the reference signals by the UE, realizes orthogonality of reference signals of shared resource blocks when the eNB schedules (on frequency resources of the same subframe) multiple UEs which share physical resource blocks using the flexible bandwidth allocation MU-MIMO manner.

In order to make the method provided by embodiments of the present invention clearer, the method for determining the reference signals will be described in further detail hereinafter. On the premise of not increasing overhead of existing physical layer control bits, the flexible bandwidth allocation MU-MIMO used in the mobile communications system (such as LTE-A) is taken as a scenario for describing the method of the embodiments of the present invention. Other scenarios are similar, and as such, the description will not be repeated. In order to not increase the overhead of the physical layer control bits, existing control information may be used in the following embodiments during practical implementations. Hereinafter, the embodiments will be described in detail respectively.

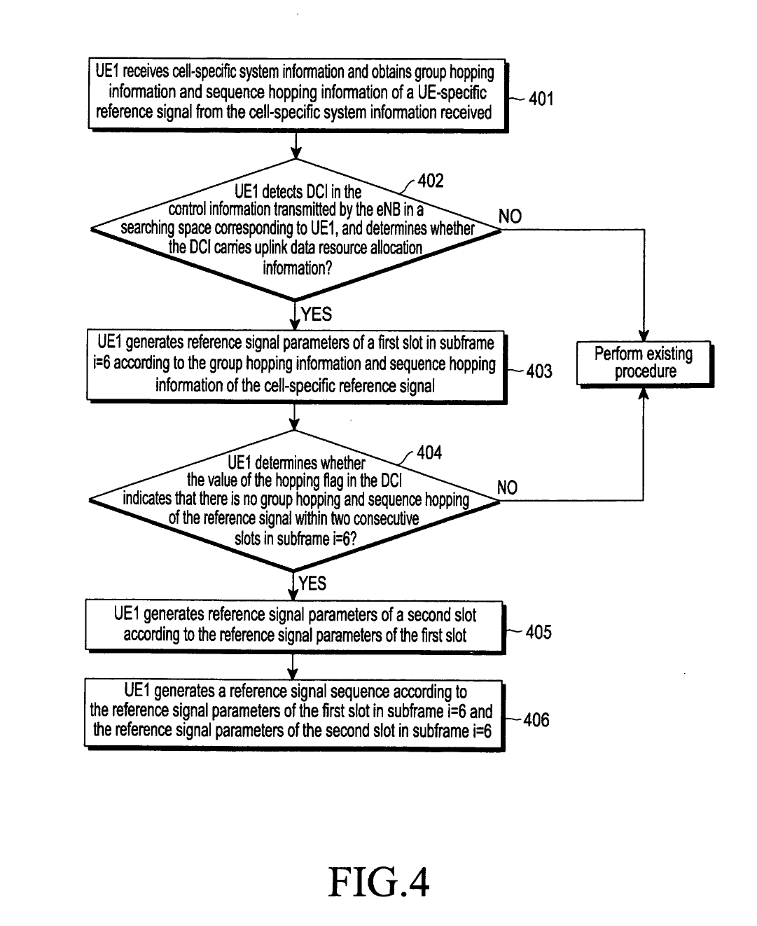

In this embodiment, suppose there are only UE1 and UE2 in a cell with cell identity N^{cell}_{ID}=5, wherein UE1 and UE2 share two PRBs for uplink data transmission among 5 PRBs, i.e. PRB₀ to PRB₄, in a subframe with, e.g. index i=6. For example, UE1 occupies PRB₀ to PRB₁ and UE2 occupies PRB₀ to PRB₄. In order to ensure the orthogonality of the reference signals of UE1 and UE2 on PRB₀ to PRB₄ so as to facilitate the demodulation of the eNB, embodiments of the present invention provide a process as shown in FIG. 4. The process may specifically include the following operations.

In block 401, UE1 receives cell-specific system information, and obtains group hopping information and sequence hopping information of a UE-specific reference signal from the cell-specific system information received.

Herein, the group hopping information and sequence hopping information may be represented by the value of a parameter group-hopping-enable of the UE-specific reference signal and the value Δₛₛ of a sequence shift, wherein the group-hopping-enable and the Δₛₛ may be configured in advance. Herein, suppose the value of the group-hopping-enable is “enable”, Δₛₛ set to be ‘6’ through a 5-bit RRC(Radio Resource Control) signaling.

In block 402, UE1 detects Downlink Control Information (DCI) in control information transmitted by the eNB in a searching space corresponding to UE1, and determines whether the DCI carries uplink data resource allocation information. If the DCI carries the uplink data resource allocation information, proceed to step 403. Otherwise, proceed to an existing procedure.

In block 402, suppose that UE1 detects in downlink subframe k=2 that the eNB transmits the uplink data resource allocation information. Thus, UE1 may transmit uplink data in subframe i=6 according to the DCI currently detected.

In block 403, UE1 generates reference signal parameters of the first slot in the subframe i=6 according to the group hopping information and sequence hopping information of the UE-specific reference signal obtained in block 401.

The reference signal parameters in block 403 may be a set including a sequence-group number u₁, a base sequence number v₁ and a cyclic shift parameter cs₁, wherein cs₁ denotes a cyclic shift parameter of the UE-specific reference signal of the first slot and is carried in the DCI transmitted by the eNB. Herein, suppose the cs₁ obtained from the DCI detected by the UE in block 402 is ‘6’. Hereinafter, generations of the sequence-group number u₁ and the base sequence number v₁ are described.

First, if the value of the parameter group-hopping-enable in the group hopping information and sequence hopping information of the UE-specific reference signal obtained in block 401 is “enable”, then v₁=0 ; thereafter, calculate u₁ according to an existing sequence-group number calculating method in the LTE. Suppose that u₁=13, then the reference signal parameters of the first slot are (u₁, v₁,cs₁)=(13,0,6) .

In block 404, UE1 determines whether the value of a hopping flag in the DCI indicates that there is no group hopping and sequence hopping of the UE-specific reference signal in two consecutive slots in subframe i=6. If yes, proceed to block 405. Otherwise, proceed to the existing procedure.

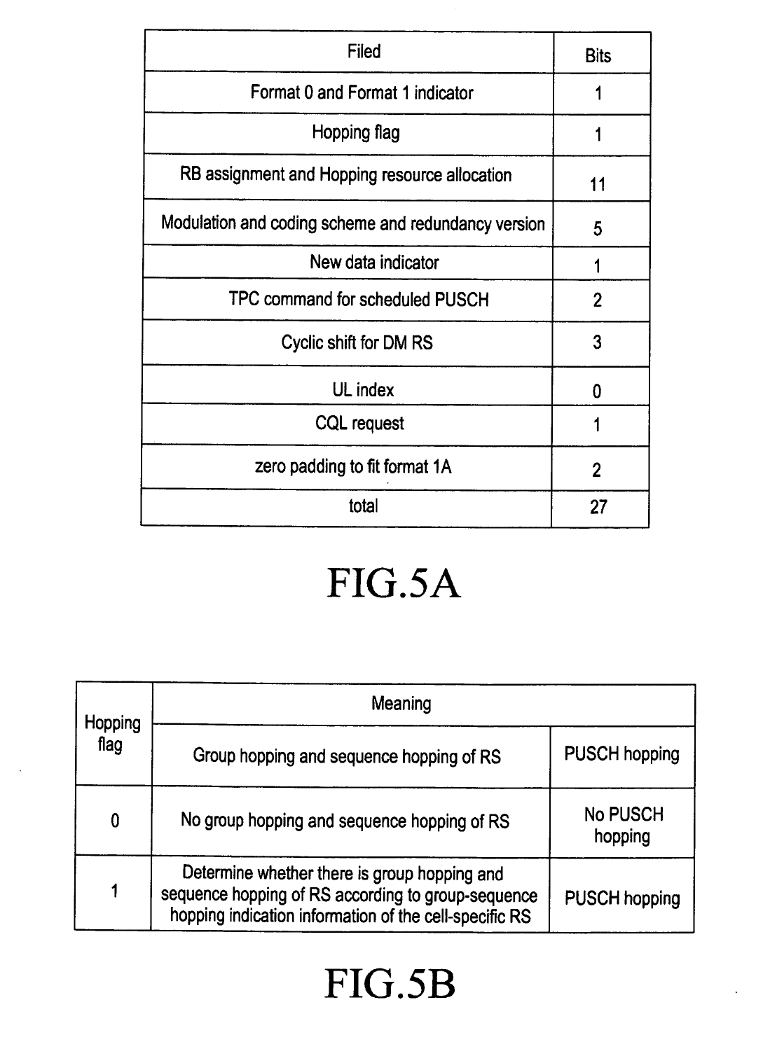

Herein, suppose the DCI in this embodiment is as shown in FIG. 5A.

Referring to FIG. 5A, the DCI comprises at least one of a Format ‘0’ and a Format ‘1’ indicator, a hopping flag, an RB assignment and Hopping resource allocation, an MCS-RV (Modulation and coding scheme and redundancy version), a new data indicator, a TPC (Transmit Power Control) command for scheduled PUSCH, a cyclic shift for DM RS (demodulation RS), a UL index, a CQI(Channel Quality Information) request, and a zero padding if needed.

Specially, the DCI contains a hopping flag which occupies one bit. In this embodiment, the value of the hopping flag is used for indicating that there is no group hopping and sequence hopping of the UE-specific reference signal within two consecutive slots in subframe 1=6 (herein, no group hopping and sequence hopping of the UE-specific reference signal means that the group hopping and sequence hopping of the UE-specific reference signal are disabled). Preferably, in this embodiment, the value ‘0’ (or the value ‘1’, depending on the embodiment) of the hopping flag may be used for indicating that there is no group hopping and sequence hopping of the UE-specific reference signal within two consecutive slots in subframe i=6, as shown in FIG. 5B.

On this basis, the determination in block 404 includes: determining whether the value of the hopping flag in the DCI is ‘0’; if the value of the hopping flag in the DCI is ‘0’, proceeding to block 405; otherwise, proceeding to the existing procedure, i.e. determining whether to perform group hopping and sequence hopping of the UE-specific reference signal according to the group information and sequence hopping information of the UE-specific reference signal.

It should be noted that, in this embodiment, it is also possible to select another name for the hopping flag which is used for indicating whether there is group hopping and sequence hopping of the UE-specific reference signal of UE1 within two consecutive slots in subframe i=6. The functions remain as described above.

In block 405, UE1 generates reference signal parameters of a second slot according to the reference signal parameters of the first slot in block 403.

Suppose the reference signal parameters of the second slot include a set of a sequence-group number u₂, a base sequence number v₂ and cs₂. Then, in block 405, the reference signal parameters of the second slot are determined according to a principle in which the sequence-group number and base sequence number of two consecutive slots in one subframe should be the same. Thus, it is obtained that u₂=u₁ and v₂=v₁. As to cs₂, it may be determined according to an existing method in the LTE. In this embodiment, suppose UE1 calculates that cs₂=3 . Then, the reference signal parameters of the second slot are (u₂,v₂,cs₂)=(13,0,3) .

In block 406, UE1 generates a reference signal sequence according to the reference signal parameters of the first slot in subframe i=6 generated in block 403 and the reference signal parameters of the second slot in subframe i=6 generated in block 405.

Herein, the operations for generating the reference signal sequence in block 406 are similar to those in the prior art and, as such, the descriptions will not be repeated herein. Thereafter, the generated reference signal sequence may be mapped to a corresponding physical resource block for uplink data transmission.

The above describes one embodiment of the present invention. It can be seen that, in the above-described embodiment, the value of the hopping flag in the DCI is used for indicating that there is no group hopping and sequence hopping of the UE-specific reference signal within two consecutive slots in subframe i=6. Preferably, other information fields, e.g. a zero padding field in the DCI, may be used for the indication. This situation will be described in another embodiment hereinafter.

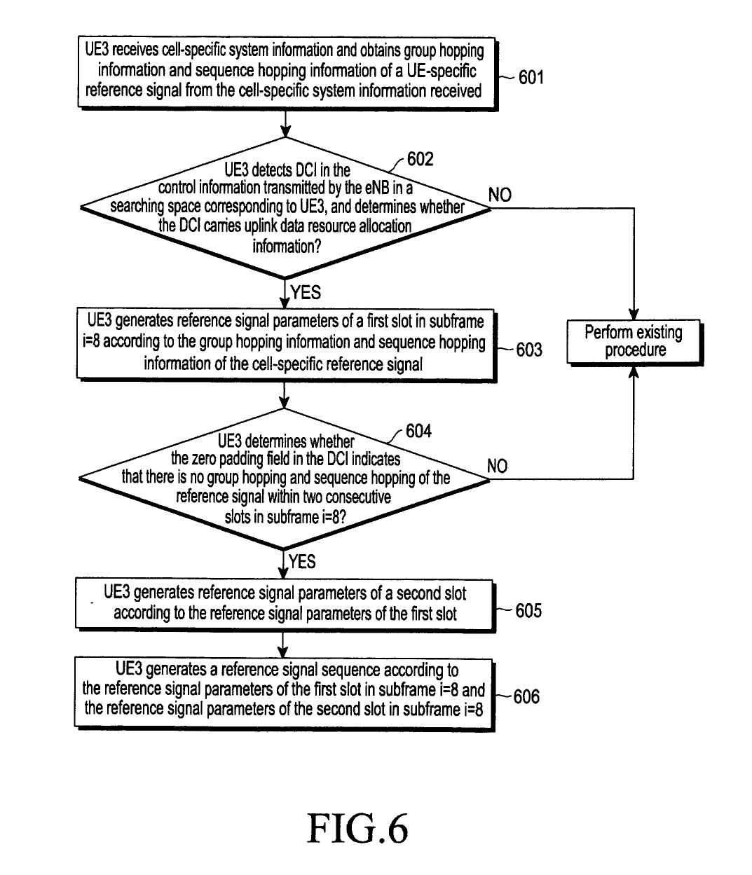

In this embodiment, suppose there are UE3 and UE4 in a cell cell with cell identity N^{cell}_{ID}=8, wherein UE3 and UE4 shares two PRBs among four PRBs, i.e. PRB₀ to PRB₃, in subframe i =8 for uplink data transmission. For example, UE3 occupies PRB₀ to PRB₁ and UE4 occupies PRB₀ to PRB₃. In order to ensure the orthogonality of the reference signals of UE3 and UE4 on PRB₀ to PRB₁ so as to facilitate the demodulation of the eNB, this embodiment provides a process as shown in FIG. 6. The process may include the following operations.

In block 601, UE3 receives cell-specific system information, and obtains group hopping information and sequence hopping information of a cell-specific reference signal from the UE-specific system information.

Similar to block 401, the group hopping information and the sequence hopping information of the reference signal in block 601 may be respectively represented by the value of group-hopping-enable and Δₛₛ. Herein, suppose the eNB configures that the value of the group-hopping-enable is “enable” and configures Δₛₛ=8 through a 5-bit RRC signaling.

Block 602 is similar to block 402.

In block 602, suppose UE3 detects the uplink data resource allocation information transmitted by the eNB in subframe k=4. Thus, it is indicated that UE3 may transmit uplink data in subframe i=8 according to the DCI currently detected.

In block 603, UE3 generates reference signal parameters of a first slot in subframe i=8 according to the group hopping information and sequence hopping information of the UE-specific reference signal obtained in block 601.

Herein, the reference signal parameters may specifically include a set of a sequence-group number v₁, a base sequence number u₁ and a cyclic shift parameter cs₁, wherein cs₁ denotes a cyclic shift parameter of the UE-specific reference signal of the first slot and is carried in the DCI transmitted by the eNB. Herein, suppose cs₁ obtained by UE3 from the DCI detected in block 602 is ‘2’. And as to v₁ and u₁, because the eNB configures the value of the group-hopping-enable to be “enable”, u₁=0. Thereafter, calculate u₁ according to an existing sequence-group number calculating method in the LTE. Suppose it is calculated that u₁=17, then the reference signal parameters of the first slot are (u₁,v₁cs₁)=(17,0,2).

In block 604, UE3 determines whether the zero padding field in the DCI indicates that there is no group hopping and sequence hopping of the UE-specific reference signal within two consecutive slots in subframe i=8. If yes, proceed to block 605; otherwise, proceed to the existing procedure.

Herein, the value of the zero padding field may be configured according to a certain criteria. Suppose the DCI in this embodiment is as shown in FIG. 5A. It can be seen from FIG. 5A that the zero padding field occupies two bits. As such, in this embodiment, it is possible to configure that, when both bits of the zero padding field are ‘1’ or at least one bit, e.g. a Most Significant Bit (MSB) or a Least Significant Bit (LSB) of the zero padding field is ‘1’, it indicates that there is no group hopping and sequence hopping of the reference signal of UE3 within two consecutive slots in subframe i=8. In this embodiment, suppose the LTE-A system defines that when the MSB of the zero padding field is ‘1’, it indicates that there is no group hopping and sequence hopping of the UE-specific reference signal within two consecutive slots in the same subframe. Thus, the determination in block 604 may include determining whether the value of the zero padding field in the DCI is ‘1’. If the value of the zero padding field in the DCI is ‘1’, proceed to block 605; otherwise, proceed to the existing procedure.

Blocks 605 to 606 are respectively similar to blocks 405 to 406.

It can be seen that the above-described embodiments are with respect to scenarios wherein the UE has a single antenna or a single data flow. As an extension of the embodiment in which there cell are only two UEs in a cell with cell identity N^{cell}_{ID}=5 , wherein the UEs share two PRBs for uplink data transmission among 5 PRBs in a subframe with, e.g. index i=6, the present invention is also applicable for scenarios where there are multiple antennas or multiple data flows, which will be described hereinafter with reference to an embodiment.

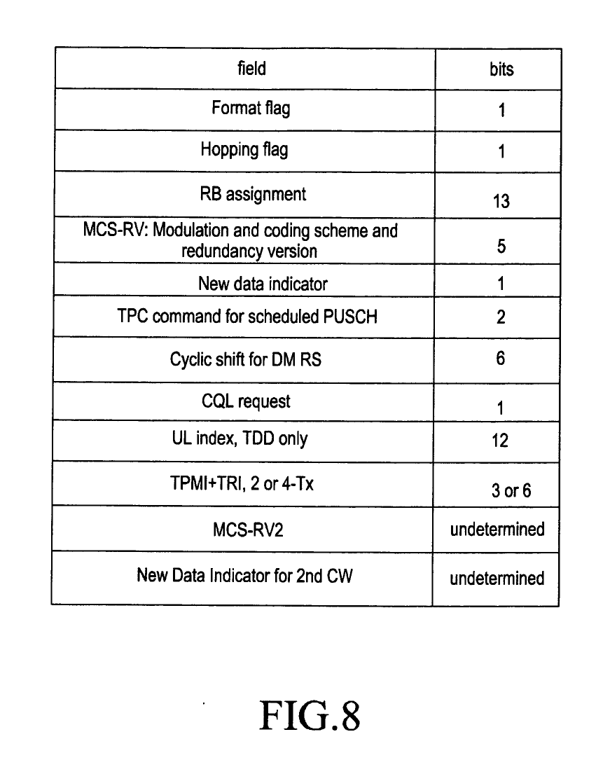

This embodiment mainly discusses a bi-antenna scenario. The principle of other scenarios such as multiple data flow scenarios is similar. Suppose there are UE5 and UE6 in a cell with cell identity N^{cell}_{ID}=9, wherein UE5 and UE6 share two PRBs for uplink data transmission among five PRBs, i.e. PRB₀ to PRB₄ in subframe i=12. For example, UE5 occupies PRB₀ to PRB₁ and UE6 occupies PRB₀ to PRB₄. In order to ensure the orthogonality of the reference signals of UE5 and UE6 on PRB₀ to PRB₁ so as to facilitate the demodulation of the eNB, in this embodiment, it is required to indicate to UE5 and UE6 whether there is group hopping and sequence hopping of the reference signal within two consecutive slots in subframe i=12. Accordingly, in the subframe i=12, the eNB schedules data of multiple layers transmitted by UE5 on the two PRBs using the DCI. Herein, similar as the above-mentioned embodiment, it is possible to let the value ‘0’ (or value ‘1’, depending on the embodiment) of the hopping flag indicate to UE5 and UE6 that there is no group hopping and sequence hopping of the reference signal within two consecutive slots in subframe i=12. And the hopping flag is no longer used for indicating frequency hopping information of the PUSCH. In the alternative, another name may be given to the hopping flag. The functions remain as described above. Suppose the DCI shown in FIG. 8 is adopted in this embodiment.

Referring to FIG. 8, the DCI comprises at least one of a format flag, a hopping flag, an RB assignment, an MCS-RV, a new data indicator, a TPC command for scheduled PUSCH, a CQI request, a UL index (TDD only), a TPMI(Transmitted Precoding Matrix Indicator) & TRI(Transmitted Rank Indicator) for two or four-Tx Antennas, an MCS-RV2, and a new data indicator for the second CW (continuous wave).

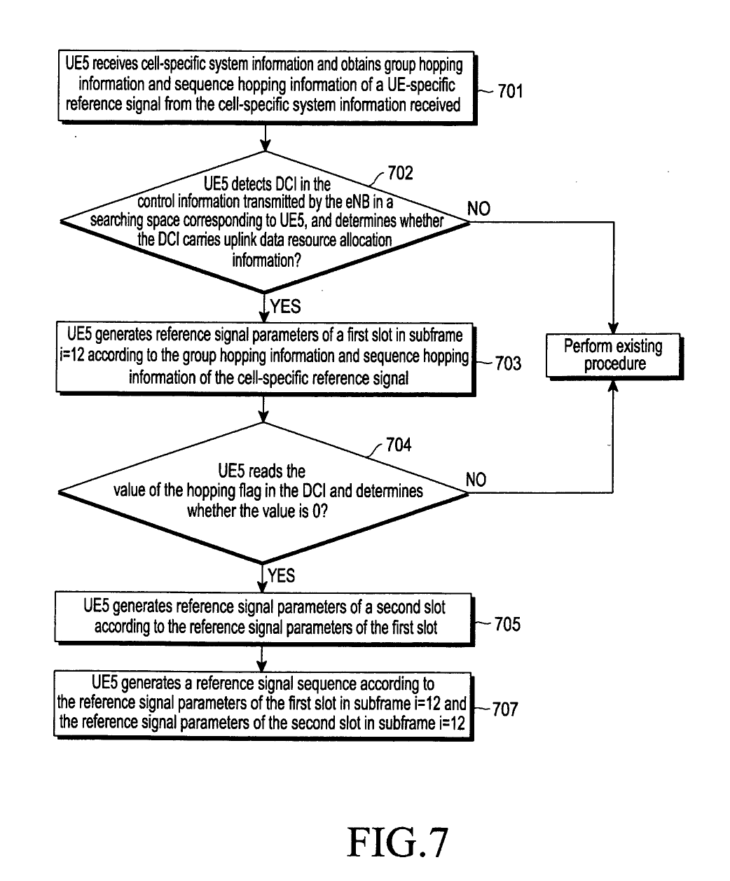

Then, as shown in FIG. 7, this embodiment may include the following operations.

In block 701, UE5 receives cell-specific system information and obtains group hopping information and sequence hopping information of a UE-specific reference signal from the cell-specific system information.

Similar to block 401, the group hopping information and the sequence hopping information in block 701 may be respectively represented by the value of the group-hopping-enable parameter and the value of Δₛₛ. Herein, suppose the eNB configures the value of the group-hopping-enable parameter as “enable” and configures Δₛₛ=21 through a 5-bit RRC signaling.

Block 702 is similar to block 402.

In block 702, suppose that UE5 detects uplink data resource allocation information transmitted by the eNB in downlink subframe k=8. Thus, it is indicated that UE5 may transmit uplink data in subframe i=12 according to the DCI currently detected.

In block 703, UE5 generates reference signal parameters of the first slot in subframe i=12 according to the group hopping information and sequence hopping information of the cell-specific reference signal obtained in block 701.

Herein, because this embodiment is with respect to the bi-antenna scenario, the reference signal parameters contained in block 703 are different from those in the previously described embodiments. During practical implementation, the reference signal parameters in this embodiment may include: a sequence-group number v₁, a base sequence number u₁, cs_{1,1} and cs_{1,2}, wherein cs_{1,j} denotes a cyclic shift parameter of the reference signal on the j th (j=1,2) antenna in the first slot and is carried in the DCI in block 702. Herein, suppose cs_{1,1} and cs_{1,2}, carried in the DCI in block 702 are respectively ‘9’ and ‘3’. With respect to u₁ and v₁ because the eNB has configured the value of the group-hopping-enable parameter as “enable”, v₁=0 Thereafter, u₁ is calculated according to an existing sequence-group number calculating method in the LTE. Suppose it is calculated that u₁=26, then the reference signal parameters of the first slot are (u₁,v₁,cs₁₁,cs₁₂)=(26,0,9,3).

Block 704, UE5 reads the value of the hopping flag in the DCI received and determines whether the value is ‘0’. If the value is ‘0’, proceed to block 705; otherwise, proceed to the existing procedure.

Herein, in this embodiment, suppose the value of the hopping flag in the DCI received is ‘0’ . Then, block 705 is performed.

In block 705, UE5 generates reference signal parameters of the second slot according to the reference signal parameters of the first slot in block 703.

Suppose the reference signal parameters of the second slot include a sequence-group number u₂ , a base sequence number v₂ cs₂₁ and cs₂₂, wherein cs_{2,j} represents a cyclic shift parameter of the reference signal on the j th (j=1,2) antenna in the second slot. Herein, in order to ensure the orthogonality of the reference signals, in block 705, the reference signal parameters of the second slot in subframe i=12 are generated according to the principle that the sequence-group numbers and base sequence numbers of two consecutive slots in the same frame should be the same. As such, it is obtained that, u₂=u₁ and v₂=v₁ . Thereafter, the values of cs₂,₁ and cs_{2,2} are calculated according to an existing method in the LTE. In this embodiment, suppose UE5 calculates that cs_{2,3}=0 and cs_{2,2}=6 . Then, the reference signal parameters of the second slot are (u₁,v₁,cs_{2,2}cs_{2,2})=(26,0,0,6).

Block 706 is similar to block 406.

It can be seen from the above technical solutions that, in the present invention, the UE is able to determine the cell-specific reference signal in subframe i according to the cell-specific system information and control information transmitted by the eNB. The eNB has no additional physical layer bit overhead. In addition, the present invention does not restrict the application scenario as the prior art. Different scenarios such as SU-MIMO, fair bandwidth allocation MU-MIMO and flexible bandwidth allocation MU-MIMO are fully considered. The method for generating the UE-specific reference signals is flexibly configured, which realizes the orthogonality of the reference signals of the shared resource blocks when the eNB schedules multiple UEs which share physical resource blocks in the flexible bandwidth allocation MU-MIMO manner on frequency resources of the same frame.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for determining reference signals, the method comprising:
obtaining, by a User Equipment (UE), at least one of group hopping information and sequence hopping information of a UE-specific reference signal from cell-specific system information broadcasted by an enhanced Node B (eNB);
receiving, by the UE, UE-specific control information transmitted by the eNB to the UE;
generating, by the UE, a UE-specific reference signal of a first slot according to at least one of the group hopping information and the sequence hopping information of the broadcasted UE-specific reference signal; and
if the UE-specific control information indicates that at least one of group hopping and sequence hopping of UE-specific reference signals is disabled, generating a UE-specific reference signal of a second slot in a same frame with the first slot according to the UE-specific reference signal of the first slot.

2. The method of claim 1, wherein a hopping flag in the UE-specific control information indicates whether at least one of the group hopping and the sequence hopping of the UE-specific reference signals is enabled.

3. The method of claim 2, wherein one of a ‘0’ value and a ‘1’ value of the hopping flag indicates that at least one of the group hopping and the sequence hopping of the UE-specific reference signals is disabled.

4. The method of claim 1, wherein a zero padding field in the UE-specific control information indicates whether at least one of the group hopping and the sequence hopping of the UE-specific reference signals is enabled.

5. The method of claim 4, wherein when the value of zero padding field is configured according to a pre-defined criteria, determining that the zero padding field indicates that at least one of the group hopping and the sequence hopping of the UE-specific reference signals is disabled.

6. The method of claim 5, wherein configuring the value of the zero padding field according to the pre-defined criteria comprises one of:
configuring all bits of the zero padding field to be ‘1’; and
configuring at least one bit of the zero padding field to be ‘1’.

7. The method of claim 6, wherein configuring at least one bit of the zero padding field to be ‘1’ comprises one of:
configuring a Most Significant Bit (MSB) of the zero padding field to be ‘1’; and
configuring a Least Significant Bit (LSB) of the zero padding field to be ‘1’.

8. The method of claim 1, wherein a new information field in the UE-specific control information indicates whether at least one of the group hopping and the sequence hopping of the UE-specific reference signals is enabled.

9. The method of claim 8, wherein the new information field comprises one of:
a hopping flag in the UE-specific control information; and
a new bit appended to the UE-specific control information.

10. The method of claim 9, wherein when the value of the new information field is one of ‘0’ and ‘1’, determining that the new information field indicates that at least one of the group hopping and the sequence hopping of the UE-specific reference signals is disabled.

11. The method of claim 1, wherein generating the UE-specific reference signal comprises generating parameters of the UE-specific reference signals, the parameters comprising at least a sequence-group number and a base sequence number.

12. An apparatus in a User Equipment (UE) for determining reference signals, the apparatus comprising:
a controller configured to obtain at least one of group hopping information and sequence hopping information of a UE-specific reference signal from cell-specific system information broadcasted by an enhanced Node B (eNB);
a receiver configured to receive UE-specific control information transmitted by the eNB to the UE; and
a generator controlled by the controller and configured to generate a UE-specific reference signal of a first slot according to at least one of the group hopping information and the sequence hopping information of the broadcasted UE-specific reference signal,
wherein the generator, if the UE-specific control information indicates that at least one of group hopping and sequence hopping of UE-specific reference signals is disabled, is further configured to generate a UE-specific reference signal of a second slot in a same frame with the first slot according to the UE-specific reference signal of the first slot.

13. The apparatus of claim 12, wherein the controller is further configured to determine whether at least one of the group hopping and the sequence hopping of the UE-specific reference signals is enabled based on a hopping flag in the UE-specific control information.

14. The apparatus of claim 13, wherein the controller is further configured to interpret that one of a ‘0’ value and a ‘1’ value of the hopping flag indicates that at least one of the group hopping and the sequence hopping of the UE-specific reference signals is disabled.

15. The apparatus of claim 12, wherein the controller is further configured to determine whether at least one of the group hopping and the sequence hopping of the UE-specific reference signals is enabled based on a zero padding field in the UE-specific control information.

16. The apparatus of claim 15, wherein the controller is further configured to determine that at least one of the group hopping and the sequence hopping of the UE-specific reference signals is disabled when a value of the zero padding field meets a pre-defined criteria.

17. The apparatus of claim 12, wherein the controller is further configured to determine whether at least one of the group hopping and the sequence hopping of the UE-specific reference signals is enabled based on a new information field in the UE-specific control information.

18. The apparatus of claim 17, wherein the new information field comprises one of:
a hopping flag in the UE-specific control information; and
a new bit appended to the UE-specific control information.

19. The apparatus of claim 17, wherein the controller is further configured to determine that at least one of the group hopping and the sequence hopping of the UE-specific reference signals is disabled when a value of the new information field is one of ‘0’ and ‘1’.

20. The apparatus of claim 12, wherein the controller is further configured to generate the UE-specific reference signal by generating parameters of the UE-specific reference signals, the parameters comprising at least a sequence-group number and a base sequence number.
